(19) United States
(12) Patent Application Publication
(10) Pub. No.: US 2026/0097739 A1
(43) Pub. Date: Apr. 9, 2026

(54) MOBILE OBJECT CONTROL APPARATUS AND MOBILE OBJECT CONTROL SYSTEM

(71) Applicant: HONDA MOTOR CO., LTD., Tokyo (JP)

(72) Inventors: Yasuharu Matsumoto, Tokyo (JP); Shohei Kamochi, Tokyo (JP); Shusaku Ito, Tokyo (JP); Naomi Sakashita, Tokyo (JP); Naoki Kikuchi, Tokyo (JP); Ko Endo, Tokyo (JP)

(21) Appl. No.: 19/348,282

(22) Filed: Oct. 2, 2025

(30) Foreign Application Priority Data
Oct. 7, 2024 (JP) 2024-175614

(51) Int. Cl. B60R 25/20; B60R 16/033; B60R 16/037; B60R 25/24

(52) U.S. Cl. CPC B60R 25/2081; B60R 16/033; B60R 16/037; B60R 25/241; B60R 2325/205

(57) ABSTRACT

A mobile object control apparatus that supplies a communication unit, a first control unit, and a second control unit with power in a power-on mode, and enables a communication standby state in the power-off mode, and, in the communication standby state, supplies the first control unit with power to allow a function setting value update process by the first control unit to be executed when the communication unit receives an update value of a function setting value transmitted from a communication apparatus and imposes a restriction on supply of power to the first control unit to return the mobile object control apparatus to the communication standby state after the function setting value update process by the first control unit is completed, and supplies the communication unit with power and imposes a restriction on supply of power in the communication standby state.

### INCORPORATION BY REFERENCE

The present application claims priority under 35 U.S.C. § 119 to Japanese Patent Application No. 2024-175614 filed on Oct. 7, 2024. The content of the application is incorporated herein by reference in its entirety.

### BACKGROUND OF THE INVENTION

### Field of the Invention

The present invention relates to a mobile object control apparatus.

### Description of the Related Art

A technology of keeping a setting value of a function built into a vehicle stored in a storage unit of a communication terminal, causing the vehicle to receive the setting value from the communication terminal by performing communication between the vehicle and the communication terminal when the vehicle is started, and setting the setting value in the vehicle has been conventionally known (see, for example, Japanese Patent Laid-Open No. 2015-150966). The technology eliminates the necessity for a user who enters the vehicle to operate an onboard apparatus and input the setting value of the vehicle function. The operational burden on the user is therefore reduced.

However, in a case where a process of receiving the setting value of the function from the communication terminal for the vehicle when the vehicle is started and setting the function of the vehicle is executed as with the technology described in Japanese Patent Laid-Open No. 2015-150966, a process performed at the time of the start of the vehicle disadvantageously causes waiting time at the time of the start of the vehicle. Accordingly, it is conceivable to perform communication between the vehicle and the communication terminal at a timing before the vehicle is started and set the setting value of the vehicle in advance. In this case, however, the vehicle out of use is started and the setting value of the vehicle function is set, which disadvantageously leads to an increase in power consumption of the vehicle in a period in which the vehicle is out of use.

Accordingly, the application seeks to execute a process of causing a mobile object such as a vehicle to change a setting value of a predetermined function built into the mobile object by receiving the setting value from a communication apparatus, while reducing waiting time at the time of the start of the mobile object and reducing power consumption of the mobile object in a period in which the mobile object is out of use.

To this end, an object of the application is to increase the operability of the mobile object. Moreover, the application improves traffic safety still more to contribute to the development of a sustainable transportation system.

### SUMMARY OF THE INVENTION

A first aspect for achieving the object includes a mobile object control apparatus including: a storage unit; a communication unit; a first control unit; a second control unit; a power supply control unit; and a power supply mode switching unit. The storage unit is configured to store a function setting value that is a setting value of a predetermined function built into a mobile object. The communication unit is configured to communicate with a communication apparatus outside the mobile object. The first control unit is configured to execute a function setting value update process of changing the function setting value stored in the storage unit to an update value of the function setting value when the communication unit receives the update value. The update value is transmitted from the communication apparatus. The second control unit is configured to change setting of the predetermined function on the basis of the function setting value stored in the storage unit. The power supply control unit is configured to control supply of power to the communication unit, the first control unit, and the second control unit. The power supply mode switching unit is configured to switch the mobile object between a power-on mode and a power-off mode in response to power-on and power-off switching operations by a user of the mobile object. The power supply control unit supplies the communication unit, the first control unit, and the second control unit with power in the power-on mode, and enables a communication standby state in the power-off mode, and, in the communication standby state, supplies the first control unit with power to allow the function setting value update process by the first control unit to be executed when the communication unit receives the update value of the function setting value transmitted from the communication apparatus and imposes a restriction on supply of power to the first control unit to return the mobile object control apparatus to the communication standby state after the function setting value update process by the first control unit is completed. The power supply control unit supplies the communication unit with power and imposes a restriction on supply of power to the first control unit and the second control unit in the communication standby state.

The mobile object control apparatus may have a configuration in which, when the power-off mode is switched to the power-on mode by the power supply mode switching unit, the first control unit transmits the function setting value stored in the storage unit to the second control unit, and the second control unit changes the setting of the predetermined function on the basis of the function setting value received from the first control unit.

The mobile object control apparatus may have a configuration in which the mobile object has a plurality of the predetermined functions, the mobile object control apparatus includes a plurality of the second control units individually corresponding to a plurality of the predetermined functions, and the first control unit individually executes the function setting value update processes for the function setting values of a plurality of the predetermined functions, and transmits the function setting value changed through the function setting value update process and stored in the storage unit to only the second control unit corresponding to the function setting value for which the function setting value update process is executed among a plurality of the second control units.

The mobile object control apparatus may have a configuration in which the mobile object is used by a plurality of the users, the communication unit receives update value data including pieces of user identification information individually set for a plurality of the users and the update values from the communication apparatus, when the update value data is received, the first control unit changes the function setting value stored in the storage unit to the update value included in the update value data and stores the function setting value in the storage unit in association with the user identification information included in the update value data, and the second control unit changes the setting of the predetermined function for each of a plurality of the users on the basis of the function setting value stored in the storage unit in association with the user identification information.

The mobile object control apparatus may have a configuration in which, when the power-off mode is switched to the power-on mode by the power supply mode switching unit, the first control unit recognizes operating user identification information that is the user identification information set for the user who performs the power-on switching operation and transmits the function setting value stored in the storage unit in association with the operating user identification information to the second control unit.

A second aspect for achieving the object includes a mobile object control system including: a mobile object control apparatus included in a mobile object; and a communication apparatus configured to communicate with the mobile object control apparatus. The mobile object control apparatus includes a storage unit, a communication unit, a first control unit, a second control unit, a power supply control unit, and a power supply mode switching unit. The storage unit is configured to store a function setting value that is a setting value of a predetermined function built into the mobile object. The communication unit is configured to communicate with the communication apparatus outside the mobile object. The first control unit is configured to execute a function setting value update process of changing the function setting value stored in the storage unit to an update value of the function setting value when the communication unit receives the update value. The update value is transmitted from the communication apparatus. The second control unit is configured to change setting of the predetermined function on the basis of the function setting value stored in the storage unit. The power supply control unit is configured to control supply of power to the communication unit, the first control unit, and the second control unit. The power supply mode switching unit is configured to switch the mobile object between a power-on mode and a power-off mode in response to power-on and power-off switching operations by a user of the mobile object. The power supply control unit supplies the communication unit, the first control unit, and the second control unit with power in the power-on mode, and enables a communication standby state in the power-off mode, and, in the communication standby state, supplies the first control unit with power to allow the function setting value update process by the first control unit to be executed when the communication unit receives the update value of the function setting value transmitted from the communication apparatus and imposes a restriction on supply of power to the first control unit to return the mobile object control apparatus to the communication standby state after the function setting value update process by the first control unit is completed. The power supply control unit supplies the communication unit with power and imposes a restriction on supply of power to the first control unit and the second control unit in the communication standby state.

The mobile object control apparatus and the mobile object control system each make it possible to execute the process of causing the mobile object to receive the setting value of the predetermined function built into the mobile object from the a communication apparatus and change the setting value while reducing waiting time at the time of the start of the mobile object and reducing power consumption of the mobile object in a period in which the mobile object is out of use.

### BRIEF DESCRIPTION OF THE DRAWINGS

FIG. 1 is a configuration diagram of a mobile object control apparatus;

FIG. 2 is an explanatory diagram of a manner in which a function setting value is stored in a central ECU and a local ECU;

FIG. 3 is a flowchart of power supply control in a power-off mode;

FIG. 4 is an explanatory diagram of a communication standby state in the power-off mode;

FIG. 5 is an explanatory diagram of a function setting value update process by the central ECU in the power-off mode;

FIG. 6 is a flowchart of a process of transmitting a function setting value at time of transition from the power-off mode to a power-on mode; and

FIG. 7 is an explanatory diagram of a situation in which an updated function setting value is transmitted from the central ECU to the local ECU.

### DETAILED DESCRIPTION OF THE INVENTION

### 1. Configuration of Mobile Object Control Apparatus

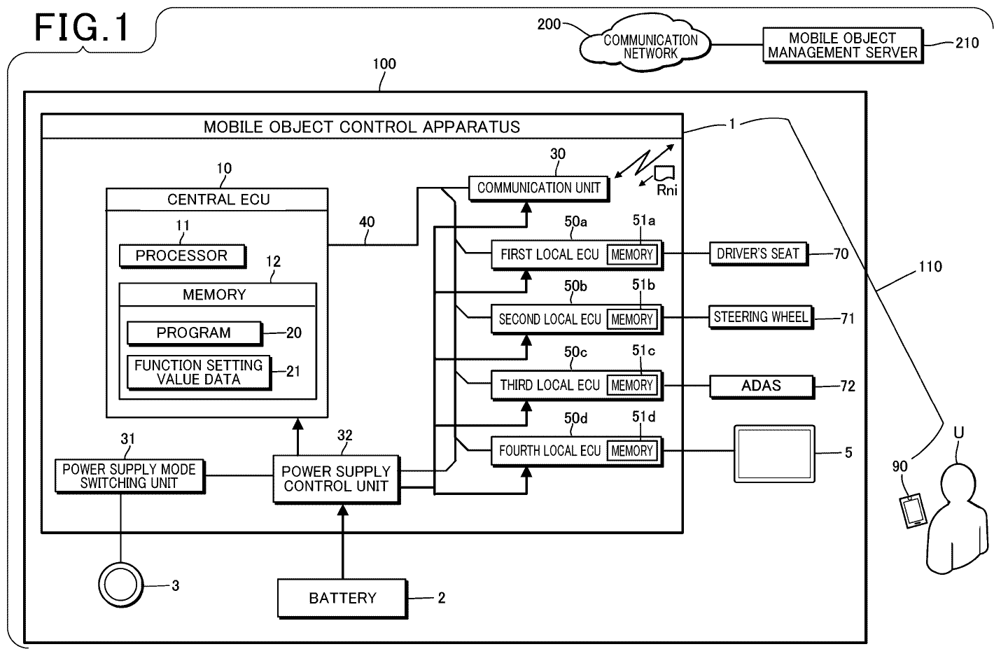

The configuration of a mobile object control apparatus 1 according to the present embodiment will be described with reference to FIG. 1. The mobile object control apparatus 1 is mounted on a vehicle 100 and controls the actuation of the vehicle 100. The vehicle 100 corresponds to a mobile object according to the present disclosure. The mobile object according to the present disclosure may be an aircraft, a vessel, or the like in addition to a vehicle. The vehicle 100 includes a battery 2 that is a power supply of electrical equipment included in the vehicle 100 and an SS (start/stop) switch 3 that instructs the vehicle 100 to be started and stopped (powered on and powered off).

Furthermore, the vehicle 100 includes a driver's seat 70 having an adjustment function of a seating position (front and back, up and down, the angle of the seat back, and the like) by an electric actuator, a steering wheel 71 having an adjustment function of tilt and telescopic positions by an electric actuator, an ADAS (Advanced Driver-Assistance Systems) 72, and a display 5 with touch panel specifications. The adjustment function of the driver's seat 70, the adjustment function of the steering wheel 71, a change function of a setting parameter of the ADAS, and a change function of a display pattern of a display screen of the display 5 each correspond to a predetermined function according to the present disclosure. The setting values of these functions each correspond to a function setting value according to the present disclosure. It is to be noted that the predetermined functions according to the present disclosure are not limited to these functions and may be a temperature setting function, an airflow rate setting function, and the like of an air conditioner.

The mobile object control apparatus 1 includes a central ECU 10, a communication unit 30, a power supply mode switching unit 31, a power supply control unit 32, a first local ECU 50a, a second local ECU 50b, a third local ECU 50c, and a fourth local ECU 50d. The central ECU 10 corresponds to a first control unit according to the present disclosure. The first local ECU 50a, the second local ECU 50b, the third local ECU 50c, and the fourth local ECU 50d each correspond to a second control unit according to the present disclosure. The following also refers to the first local ECU 50a, the second local ECU 50b, the third local ECU 50c, and the fourth local ECU 50d collectively as local ECUs 50. In addition, memories 51a to 51d included in the first local ECU 50a, the second local ECU 50b, the third local ECU 50c, and the fourth local ECU 50d will also be referred to collectively as memories 51.

The communication unit 30 communicates with a mobile object management server 210 that manages the usage status of a mobile object such as the vehicle 100, a portable terminal 90 that is used by a user U of the vehicle 100, and the like through a communication network 200. The portable terminal 90 corresponds to a communication apparatus according to the present disclosure, and the portable terminal 90 and the mobile object control apparatus 1 are included in a mobile object control system 110. It is to be noted that the communication between the communication unit 30 and the portable terminal 90 may be performed through direct communication without interposing the communication network 200. The portable terminal 90 is a smart key, a smartphone, a cell phone, or the like.

The central ECU 10 is a control unit including a processor 11 and a memory 12 and the local ECUs 50 are also control units each including a processor and the memory 51. The central ECU 10, the communication unit 30, the local ECUs 50, and the power supply control unit 32 are connected by a communication bus 40 and communicate with each other. The power supply mode switching unit 31 switches the vehicle 100 between a power-on mode and a power-off mode in response to a power-on operation and a power-off operation on the SS switch 3. The power supply control unit 32 controls the supply and stop of power (corresponding to a restriction according to the present disclosure) to the central ECU 10 and the local ECUs 50 in response to the switch between the power-on mode and the power-off mode. It is to be noted that a restriction may be imposed to enable a state in which the supply of power to the local ECUs 50 is not completely stopped and low power is supplied.

The central ECU 10 recognizes user ID (identification) of the user U who enters the vehicle 100 by obtaining the user ID of the user U through communication with the portable terminal 90 carried by the user U. The user ID corresponds to user identification information according to the present disclosure.

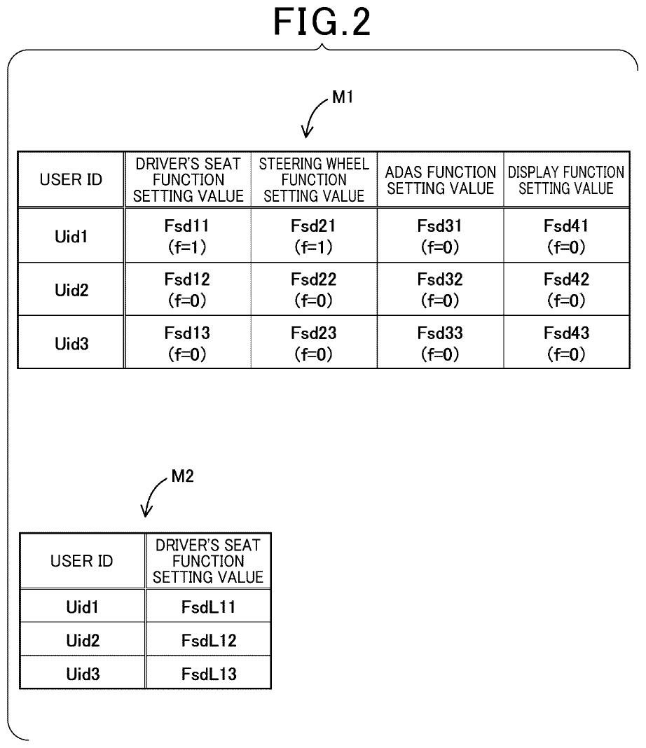

The first local ECU 50a changes a function setting value that is a setting value of the position adjustment function of the driver's seat 70 and stores the function setting value in the memory 51a in response to an adjustment operation (such as an operation on an adjustment switch) on the position of the driver's seat by the user U. As illustrated in M2 of FIG. 2, the memory 51a stores function setting values FsdL11 to FsdL13 for a plurality of users (three users are exemplified here) who uses the vehicle 100 in association with the user IDs of the respective users. The first local ECU 50a changes the setting position of the driver's seat on the basis of the function setting value corresponding to the user ID of the user U stored in the memory 51a when the user U enters the vehicle 100 and performs a power-on operation on the SS switch 3.

The second local ECU 50b changes a function setting value that is a setting value of the position adjustment function of the steering wheel 71 and stores the function setting value in the memory 51b in response to an adjustment operation (such as an operation on an adjustment switch) on the operation position of the steering wheel 71 by the user U. As with the memory 51a described above, the memory 51b stores the function setting values of the steering wheel 71 for a plurality of users. The second local ECU 50b changes the setting position of the steering wheel 71 on the basis of the function setting value corresponding to the user ID of the user U stored in the memory 51b when the user U enters the vehicle 100 and performs a power-on operation on the SS switch 3.

The third local ECU 50c changes a function setting value that is a setting value of a variable parameter of the ADAS 72 and stores the function setting value in the memory 51c in response to a setting operation on the variable parameter of the ADAS 72 by the user U. The variable parameter is the inter-vehicle distance to a preceding vehicle under ACC (Adaptive Cruise Control), the time elapsed from the discovery and detection of a preceding vehicle to a notification in a preceding vehicle departure notification, or the like. As with the memory 51a described above, the memory 51c stores the function setting values of the ADAS 72 for a plurality of users. The third local ECU 50c changes the variable parameter of the ADAS 72 on the basis of the function setting value corresponding to the user ID of the user U stored in the memory 51c when the user U enters the vehicle 100 and performs a power-on operation on the SS switch 3.

The fourth local ECU 50d changes a function setting value that is a setting value of a screen display pattern of the display 5 and stores the function setting value in the memory 51d in response to a selection operation on the screen display pattern of the display 5 by the user U. As with the memory 51a described above, the memory 51d stores the function setting values of the display 5 for a plurality of users. The fourth local ECU 50d sets the screen display pattern of the display 5 on the basis of the function setting value corresponding to the user ID of the user U stored in the memory 51d when the user U enters the vehicle 100 and performs a power-on operation on the SS switch 3.

In addition, it is possible for the user U to change the function setting values of the driver's seat 70, the steering wheel 71, the ADAS 72, and the display 5 by executing a remote operation application for the vehicle 100 installed in the portable terminal 90. In this case, update value data Rni including the changed function setting values (update values of the function setting values) and the user ID of the user U is transmitted to the vehicle 100 through the communication network 200. It is to be noted that the update value data Rni may be transmitted from the portable terminal 90 to the vehicle 100 through the mobile object management server 210.

As illustrated in M1 of FIG. 2, the central ECU 10 executes a function setting value update process of recording and storing the received update value data Rni in function setting value data 21 in the memory 12 for each of the user IDs in association with the user ID. The central ECU 10 then transmits the update value data Rni recorded in the function setting value data 21 to the local ECU 50 that controls the corresponding function and the local ECU 50 that receives the update value data Rni changes the function setting value stored in the memory 51 to the update value included in the update value data Rni.

### 2. Processes in Power-Off Mode

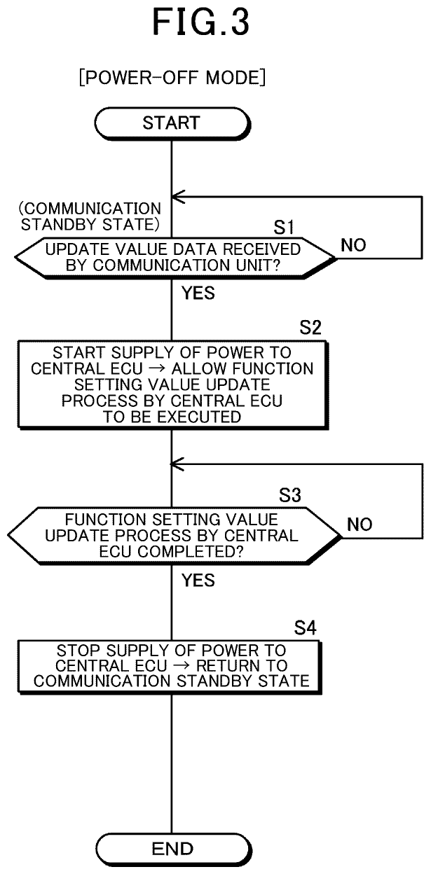

Processes by the power supply control unit 32 in the power-off mode will be described in accordance with the flowchart illustrated in FIG. 3. The power supply control unit 32 repeatedly executes the processes compliant with the flowchart illustrated in FIG. 3 at the time of the power-off mode.

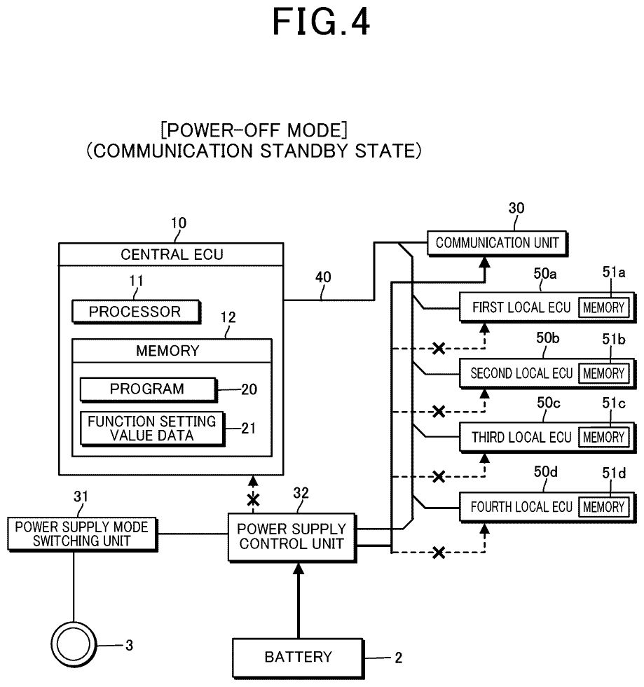

In step S1 in FIG. 3, the power supply control unit 32 repeatedly executes a process of determining whether or not the communication unit 30 receives the update value data Rni from the mobile object management server 210 (communication standby state), and advances the process to step S2 when the update value data Rni is received. Here, FIG. 4 illustrates a manner in which power supply is controlled in the communication standby state. The power supply control unit 32 stops the supply of power from the battery 2 to the central ECU 10 and the local ECUs 50 and supplies only the communication unit 30 with power. This makes it possible to reduce power to be consumed in the power-off mode.

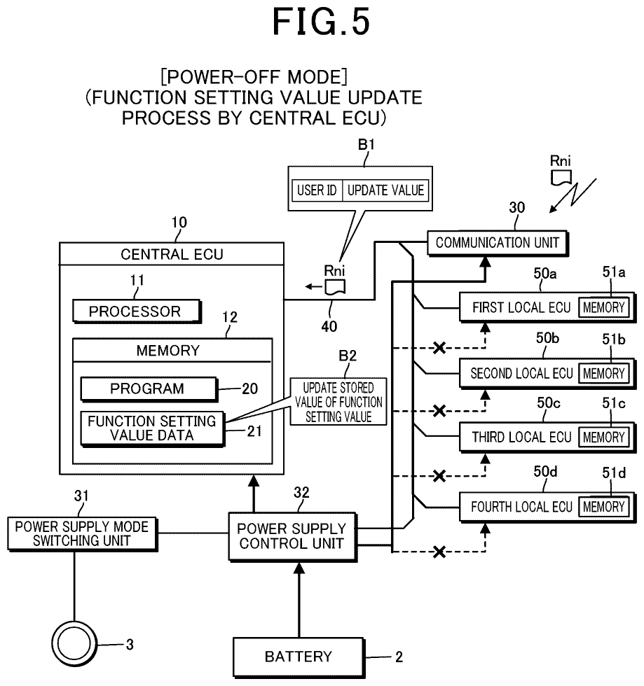

In step S2, the power supply control unit 32 starts the supply of power to the central ECU 10. This starts the central ECU 10 and allows a function setting value update process by the central ECU 10 to be executed. Here, FIG. 5 illustrates a manner in which the central ECU 10 executes a function setting value update process in the power-off mode. The power supply control unit 32 keeps the supply of power to the local ECUs 50 stopped and supplies the central ECU 10 with power.

This starts the central ECU 10. The central ECU 10 obtains the update value data Rni received by the communication unit 30 through the communication bus 40 and executes a function setting value update process of changing the stored value of the corresponding function setting value in the function setting value data 21 to the update value included in the update value data Rni using the user ID and the update value as illustrated in a speech balloon B1.

As illustrated in M1 of FIG. 2, the central ECU 10 records the update status of each of the function setting values in the function setting value data 21 using the value (0 or 1) of a flag f. That is, the central ECU 10 sets the flag f of the updated function setting value to “1” and sets the flag f to “0” when the updated function setting value is transmitted to the corresponding local ECU 50 as described below. This makes it possible to determine whether the updated function setting values have been transmitted to the corresponding local ECUs 50 (f=0) or have not yet been transmitted to the corresponding local ECUs 50 (f=1) by checking the values of the flags f of the respective function setting values.

In subsequent step S3, the power supply control unit 32 determines whether or not the function setting value update process by the central ECU 10 is completed through communication with the central ECU 10. When the function setting value update process by the central ECU 10 is completed, the power supply control unit 32 advances the process to step S4. In step S4, the power supply control unit 32 stops the supply of power to the central ECU 10. This returns the mobile object control apparatus 1 to the communication standby state.

The processes of the flowchart illustrated in FIG. 3 limit the supply of power to the central ECU 10 in the power-off mode to only a period in which the communication unit 30 receives the update value data Rni and the central ECU 10 executes a function setting value update process. In the other periods, the supply of power to the central ECU 10 remains stopped. This makes it possible to reduce power to be consumed by the mobile object control apparatus 1 in the power-off mode.

### 3. Processes at Time of Switch From Power-Off Mode to Power-On Mode

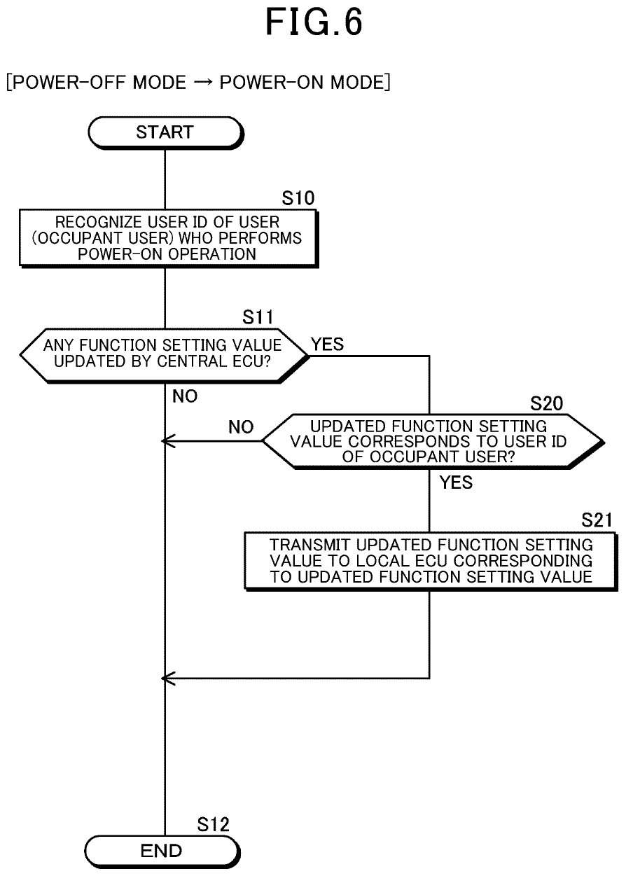

Next, processes executed by the central ECU 10 at the time of a switch from the power-off mode to the power-on mode will be described in accordance with the flowchart illustrated in FIG. 6. In step S10 in FIG. 6, the central ECU 10 recognizes the user ID of the user U (referred to as an occupant user below) who enters the vehicle 100 and performs a power-on operation on the SS switch 3.

In subsequent step S11, the central ECU 10 determines whether or not any function setting value is updated (any function setting value that satisfies the flag f=1 in M1 illustrated in FIG. 2) with reference to the function setting value data 21 in the memory 12. The central ECU 10 then advances the process to step S20 in a case where any function setting value is updated. In a case where no function setting value is updated, the central ECU 10 advances the process to step S12.

In step S20, the central ECU 10 determines whether or not the updated function setting value is the function setting value corresponding to the user ID of the occupant user. The central ECU 10 then advances the process to step S21 when the updated function setting value is the function setting value corresponding to the user ID of the occupant user. When the updated function setting value is not the function setting value corresponding to the user ID of the occupant user, the central ECU 10 advances the process to step S12.

For example, in the example in M1 of FIG. 2, the flag f of a function setting value Fsd11 of the driver's seat corresponding to a user ID Uid1 is “1”. The central ECU 10 therefore advances the process from step S20 to step S21 when the user ID of the occupant user is Uid1.

In step S21, the central ECU 10 then transmits the updated function setting value Fsd11 corresponding to the occupant user to the first local ECU 50a corresponding to the updated function setting value.

As illustrated in M2 of FIG. 2, the first local ECU 50a that receives the function setting value Fsd11 received from the central ECU 10 updates FsdL11 stored in association with the user ID-Uid1 by changing FsdL11 to Fsd11.

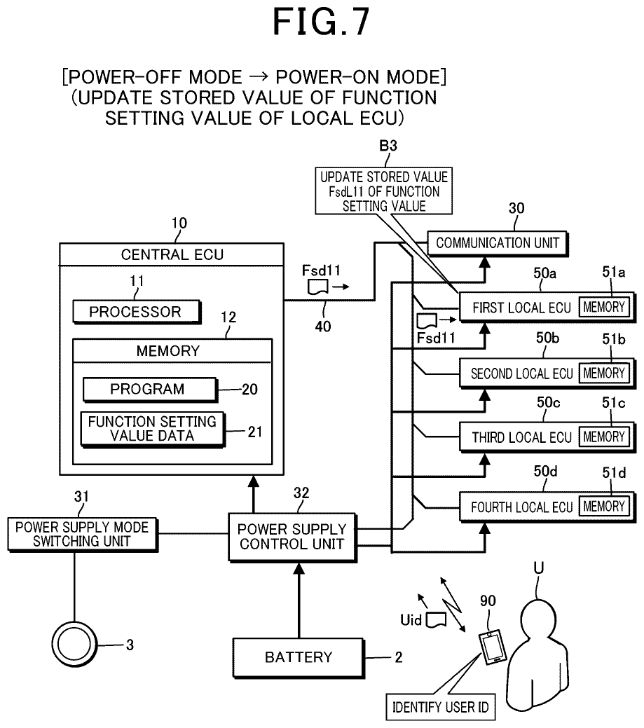

Here, FIG. 7 illustrates a situation in which the central ECU 10 transmits the update value Fsd11 to the first local ECU 50a as a state in which the power-off mode is switched to the power-on mode and the power supply control unit 32 supplies the central ECU 10 and the local ECUs 50 with power. As illustrated in a speech balloon B3, the first local ECU 50a updates the function setting value FsdL11 of the driver's seat 70 corresponding to the user ID-Uid1 stored in the memory 51a using the received update value Fsd11.

In this way, in a case where the central ECU 10 executes a function setting value update process in the power-off mode, the central ECU 10 performs the transmission of a function setting value to the local ECU 50 at the time of a switch to the power-on mode by limiting the transmission of the function setting value to a case where the user corresponding to the updated function setting value enters the vehicle. In addition, the central ECU 10 performs the transmission of a function setting value by limiting the transmission of the function setting value to the first local ECU 50a corresponding to an updated function setting value instead of all the local ECUs 50. This makes it possible to reduce the amount of communication between the central ECU 10 and the local ECUs 50 and efficiently update the function setting values stored in the memories 51 of the local ECUs 50.

### 4. Other Embodiments

In the embodiment, the central ECU 10 transmits an updated function setting value to a local ECU by limiting the transmission of the function setting value to a case where a function setting value corresponding to an occupant user is updated as illustrated in FIG. 6. As another embodiment, the updated function setting value may be transmitted from the central ECU 10 to the local ECU 50 without identifying the user ID of the occupant user.

In the embodiment, the central ECU 10 transmits an updated function setting value by limiting the transmission of the function setting value to only the local ECU 50 corresponding to the updated function setting value as illustrated in FIG. 6. As another embodiment, the corresponding function setting values recorded in the function setting value data 21 may be transmitted to all the local ECUs 50.

It is to be noted that FIG. 1 is a schematic diagram in which the configuration of the mobile object control apparatus 1 is divided in accordance with the chief processing contents for facilitating the understandings of the invention of the application, and the mobile object control apparatus 1 may be configured in accordance with other division. In addition, a process of each of the components may be executed by one hardware unit or executed by a plurality of hardware units. In addition, a process by each of the components illustrated in FIGS. 3 and 6 may be executed by one program or executed by a plurality of programs.

### 5. Configurations Supported by Above Embodiments

The embodiments are specific examples of the following configurations.

(Configuration 1) A mobile object control apparatus including: a storage unit configured to store a function setting value that is a setting value of a predetermined function built into a mobile object; a communication unit configured to communicate with a communication apparatus outside the mobile object; a first control unit configured to execute a function setting value update process of changing the function setting value stored in the storage unit to an update value of the function setting value when the communication unit receives the update value, the update value being transmitted from the communication apparatus; a second control unit configured to change setting of the predetermined function on the basis of the function setting value stored in the storage unit; a power supply control unit configured to control supply of power to the communication unit, the first control unit, and the second control unit; and a power supply mode switching unit configured to switch the mobile object between a power-on mode and a power-off mode in response to power-on and power-off switching operations by a user of the mobile object, in which the power supply control unit supplies the communication unit, the first control unit, and the second control unit with power in the power-on mode, and enables a communication standby state in the power-off mode, and, in the communication standby state, supplies the first control unit with power to allow the function setting value update process by the first control unit to be executed when the communication unit receives the update value of the function setting value transmitted from the communication apparatus and stops supply of power to the first control unit to return the mobile object control apparatus to the communication standby state after the function setting value update process by the first control unit is completed, the power supply control unit supplying the communication unit with power and stopping supply of power to the first control unit and the second control unit in the communication standby state.

The mobile object control apparatus according to Configuration 1 makes it possible to execute a process of causing the mobile object to receive the setting value of the predetermined function built into the mobile object from the communication apparatus and change the setting value while reducing waiting time at the time of the start of the mobile object and reducing power consumption of the mobile object in a period in which the mobile object is out of use.

(Configuration 2) The mobile object control apparatus according to Configuration 1, in which, when the power-off mode is switched to the power-on mode by the power supply mode switching unit, the first control unit transmits the function setting value stored in the storage unit to the second control unit, and the second control unit changes the setting of the predetermined function on the basis of the function setting value received from the first control unit.

The mobile object control apparatus according to Configuration 2 makes it possible to quickly make the setting of the predetermined function by the second control unit by transmitting the updated function setting value from the first control unit to the second control unit at the timing at which the mobile object is switched from the power-off mode to the power-on mode.

(Configuration 3) The mobile object control apparatus according to Configuration 2, in which the mobile object has a plurality of the predetermined functions, the mobile object control apparatus includes a plurality of the second control units individually corresponding to a plurality of the predetermined functions, and the first control unit individually executes the function setting value update processes for the function setting values of a plurality of the predetermined functions, and transmits the function setting value changed through the function setting value update process and stored in the storage unit to only the second control unit corresponding to the function setting value for which the function setting value update process is executed among a plurality of the second control units.

The mobile object control apparatus according to Configuration 3 makes it possible to reduce the amount of communication between the first control unit and the plurality of second control units and prevent the waiting time at the time of the start of the mobile object from increasing due to the communication by executing the transmission of function setting values from the first control unit to the second control units by limiting the transmission of the function setting values from the first control unit to the second control units to the second control unit corresponding to an updated function setting value.

(Configuration 4) The mobile object control apparatus according to any one of Configurations 1 to 3, in which the mobile object is used by a plurality of the users, the communication unit receives update value data from the communication apparatus, the update value data including pieces of user identification information individually set for a plurality of the users and the update values, when the update value data is received, the first control unit changes the function setting value stored in the storage unit to the update value included in the update value data and stores the function setting value in the storage unit in association with the user identification information included in the update value data, and the second control unit changes the setting of the predetermined function for each of a plurality of the users on the basis of the function setting value stored in the storage unit in association with the user identification information.

The mobile object control apparatus according to Configuration 4 makes it possible to change, in a case where the mobile object is used by the plurality of users, the setting of the predetermined function for each of the users. The setting of the predetermined function corresponds to each of the users.

(Configuration 5) The mobile object control apparatus according to Configuration 4, in which, when the power-off mode is switched to the power-on mode by the power supply mode switching unit, the first control unit recognizes operating user identification information that is the user identification information set for the user who performs the power-on switching operation and transmits the function setting value stored in the storage unit in association with the operating user identification information to the second control unit.

The mobile object control apparatus according to Configuration 5 makes it possible to reduce the amount of communication between the first control unit and the plurality of second control units and prevent the waiting time at the time of the start of the mobile object from increasing due to the communication by executing the transmission of function setting values from the first control unit to the second control units by limiting the transmission of the function setting values from the first control unit to the second control units to a case where the function setting value corresponding to the user identification information about a user who enters the mobile object and performs the power-on switching operation is updated.

(Configuration 6) A mobile object control system including: a mobile object control apparatus included in a mobile object; and a communication apparatus configured to communicate with the mobile object control apparatus, in which the mobile object control apparatus includes a storage unit configured to store a function setting value that is a setting value of a predetermined function built into the mobile object, a communication unit configured to communicate with the communication apparatus outside the mobile object, a first control unit configured to execute a function setting value update process of changing the function setting value stored in the storage unit to an update value of the function setting value when the communication unit receives the update value, the update value being transmitted from the communication apparatus, a second control unit configured to change setting of the predetermined function on the basis of the function setting value stored in the storage unit, a power supply control unit configured to control supply of power to the communication unit, the first control unit, and the second control unit, and a power supply mode switching unit configured to switch the mobile object between a power-on mode and a power-off mode in response to power-on and power-off switching operations by a user of the mobile object, and the power supply control unit supplies the communication unit, the first control unit, and the second control unit with power in the power-on mode, and enables a communication standby state in the power-off mode, and, in the communication standby state, supplies the first control unit with power to allow the function setting value update process by the first control unit to be executed when the communication unit receives the update value of the function setting value transmitted from the communication apparatus and imposes a restriction on supply of power to the first control unit to return the mobile object control apparatus to the communication standby state after the function setting value update process by the first control unit is completed, the power supply control unit supplying the communication unit with power and imposing a restriction on supply of power to the first control unit and the second control unit in the communication standby state.

The mobile object control system according to Configuration 6 makes it possible to execute a process of causing the mobile object to receive the setting value of the predetermined function built into the mobile object from the communication apparatus and change the setting value while reducing waiting time at the time of the start of the mobile object and reducing power consumption of the mobile object in a period in which the mobile object is out of use.

### REFERENCE SIGNS LIST

1 mobile object control apparatus
2 battery
3 SS switch
5 display
10 central ECU (first control unit)
11 processor
12 memory
20 program
21 function setting value data
30 communication unit
31 power supply mode switching unit
32 power supply control unit
50a first local ECU
50b second local ECU
50c third local ECU
50d fourth local ECU
70 driver's seat
71 steering wheel
72 ADAS
90 portable terminal
100 vehicle (mobile object)
110 mobile object control system
200 communication network
210 mobile object management server
U user

1. A mobile object control apparatus comprising:
a storage unit configured to store a function setting value that is a setting value of a predetermined function built into a mobile object;
a communication unit configured to communicate with a communication apparatus outside the mobile object;
a first control unit configured to execute a function setting value update process of changing the function setting value stored in the storage unit to an update value of the function setting value when the communication unit receives the update value, the update value being transmitted from the communication apparatus;
a second control unit configured to change setting of the predetermined function on a basis of the function setting value stored in the storage unit;
a power supply control unit configured to control supply of power to the communication unit, the first control unit, and the second control unit; and
a power supply mode switching unit configured to switch the mobile object between a power-on mode and a power-off mode in response to power-on and power-off switching operations by a user of the mobile object, wherein
the power supply control unit
supplies the communication unit, the first control unit, and the second control unit with power in the power-on mode, and
enables a communication standby state in the power-off mode, and, in the communication standby state, supplies the first control unit with power to allow the function setting value update process by the first control unit to be executed when the communication unit receives the update value of the function setting value transmitted from the communication apparatus and imposes a restriction on supply of power to the first control unit to return the mobile object control apparatus to the communication standby state after the function setting value update process by the first control unit is completed, the power supply control unit supplying the communication unit with power and imposing a restriction on supply of power to the first control unit and the second control unit in the communication standby state.

2. The mobile object control apparatus according to claim 1, wherein
when the power-off mode is switched to the power-on mode by the power supply mode switching unit, the first control unit transmits the function setting value stored in the storage unit to the second control unit, and
the second control unit changes the setting of the predetermined function on a basis of the function setting value received from the first control unit.

3. The mobile object control apparatus according to claim 2, wherein
the mobile object has a plurality of the predetermined functions,
the mobile object control apparatus comprises a plurality of the second control units individually corresponding to a plurality of the predetermined functions, and
the first control unit
individually executes the function setting value update processes for the function setting values of a plurality of the predetermined functions, and
transmits the function setting value changed through the function setting value update process and stored in the storage unit to only the second control unit corresponding to the function setting value for which the function setting value update process is executed among a plurality of the second control units.

4. The mobile object control apparatus according to claim 1, wherein
the mobile object is used by a plurality of the users,
the communication unit receives update value data from the communication apparatus, the update value data including pieces of user identification information individually set for a plurality of the users and the update values,
when the update value data is received, the first control unit changes the function setting value stored in the storage unit to the update value included in the update value data and stores the function setting value in the storage unit in association with the user identification information included in the update value data, and
the second control unit changes the setting of the predetermined function for each of a plurality of the users on a basis of the function setting value stored in the storage unit in association with the user identification information.

5. The mobile object control apparatus according to claim 4, wherein, when the power-off mode is switched to the power-on mode by the power supply mode switching unit, the first control unit recognizes operating user identification information that is the user identification information set for the user who performs the power-on switching operation and transmits the function setting value stored in the storage unit in association with the operating user identification information to the second control unit.

6. A mobile object control system comprising:
a mobile object control apparatus included in a mobile object; and
a communication apparatus configured to communicate with the mobile object control apparatus, wherein
the mobile object control apparatus includes
a storage unit configured to store a function setting value that is a setting value of a predetermined function built into the mobile object,
a communication unit configured to communicate with the communication apparatus outside the mobile object,
a first control unit configured to execute a function setting value update process of changing the function setting value stored in the storage unit to an update value of the function setting value when the communication unit receives the update value, the update value being transmitted from the communication apparatus,
a second control unit configured to change setting of the predetermined function on a basis of the function setting value stored in the storage unit,
a power supply control unit configured to control supply of power to the communication unit, the first control unit, and the second control unit, and
a power supply mode switching unit configured to switch the mobile object between a power-on mode and a power-off mode in response to power-on and power-off switching operations by a user of the mobile object, and
the power supply control unit
supplies the communication unit, the first control unit, and the second control unit with power in the power-on mode, and
enables a communication standby state in the power-off mode, and, in the communication standby state, supplies the first control unit with power to allow the function setting value update process by the first control unit to be executed when the communication unit receives the update value of the function setting value transmitted from the communication apparatus and imposes a restriction on supply of power to the first control unit to return the mobile object control apparatus to the communication standby state after the function setting value update process by the first control unit is completed, the power supply control unit supplying the communication unit with power and imposing a restriction on supply of power to the first control unit and the second control unit in the communication standby state.
